(19) United States
(12) Patent Application Publication
(10) Pub. No.: US 2015/0258507 A1
(43) Pub. Date: Sep. 17, 2015

(54) Osmosis Membrane Unit, Osmotic Pressure Power Generator, Osmosis Membrane Treatment Unit, Method of Manufacturing Osmosis Membrane Unit

(71) Applicant: Kabushiki Kaisha Toshiba, Tokyo (JP)

(72) Inventors: Kenji Sano, Tokyo (JP); Toshihiro Imada, Kawasaki (JP)

(21) Appl. No.: 14/603,880

(22) Filed: Jan. 23, 2015

(30) Foreign Application Priority Data
Mar. 14, 2014 (JP) 2014-051919

(51) Int. Cl. B01D 71/02; H02K 7/18; B05D 1/18; B01D 69/02; B01D 61/08

(52) U.S. Cl. CPC B01D 71/022; B01D 69/02; B01D 61/08; B05D 1/18; H02K 7/1823; B01D 2319/04; B01D 2323/36

(57) ABSTRACT

According to one embodiment, an osmosis membrane unit has an osmotic pressure inductor and an osmosis membrane. The osmotic pressure inductor is one in which a salt-structure compound has been made to react with a reticulate member composed of metal. The osmosis membrane is disposed to contact at least one surface of the osmotic pressure inductor.

### CROSS-REFERENCE TO RELATED APPLICATIONS

This application is based upon and claims the benefit of priority from Japanese Patent Application No. 2014-051919, .filed Mar. 14, 2014, the entire contents of which are incorporated herein by reference.

### FIELD

Embodiments described herein relate generally to an osmosis membrane unit, an osmotic pressure power generator, an osmosis membrane treatment unit, and a method of manufacturing an osmosis membrane unit.

### BACKGROUND

Seawater-to-freshwater conversion method is known as a technology that utilizes differences in osmotic pressure. As a means for desalinating seawater to produce freshwater, the reverse osmosis membrane (RO membrane) technique is widely applied. The reverse osmosis membrane technique is a method which conducts desalination by applying pressure to an osmosis membrane in the reverse direction of osmotic pressure to extract freshwater from seawater. In the desalination method referred to as the forward osmosis membrane (FO membrane) technique, a similar osmosis membrane is used, aqueous ammonium carbonate solution of higher concentration than seawater is disposed on the support membrane side, and freshwater is drawn in by the osmotic pressure of the ammonium carbonate without application of pressure. Subsequently, the ammonium carbonate solution is heated to separate the carbon and the ammonia, and extract them from the water, leaving freshwater.

With a desalination device that utilizes osmotic pressure in the above-described manner, in order to support an osmosis membrane such as an RO membrane or an FO membrane that is exposed to high water pressure, it is often the case that a structural object called an “element” is used that is configured as a cylindrical roll, with a structure where a reticulate body is inserted between osmosis membranes.

With respect to this type of element, the reticulate body formed from synthetic fiber supports the overall structure. In the case where such a reticulate body is not used, it is necessary to insert a support like a perforated plate under the osmosis membrane.

The reticulate body that supports the aforementioned osmosis membrane preferably has a high aperture ratio for purposes of smooth passage of seawater. However, on the other hand, the strength of the reticulate body declines when its aperture ratio increases, which may limit the pressure that can be applied by seawater, and reduce osmotic efficiency.

With the forward osmosis technique, the cost of producing freshwater may be increased by the decomposition of ammonium carbonate during heating.

Osmotic pressure power generation is known as another technology that utilizes osmotic pressure. With this power generation method, the freshwater and the condensed seawater that is produced when seawater is desalinated and converted to freshwater are brought into contact via a forward osmosis membrane. Furthermore, an osmotic pressure power generator is being developed wherein the pressure of condensed seawater is raised by having freshwater pass through to the condensed seawater side by utilizing the osmotic pressure differential between condensed seawater and freshwater, and the condensed seawater is utilized as a drive medium for power generation turbines. With an osmotic pressure power generator, power generation efficiency improves as the amount of freshwater that penetrates the forward osmosis membrane increases. Consequently, in order to efficiently conduct power generation, it is necessary to raise the amount of freshwater that penetrates the forward osmosis membrane.

### BRIEF DESCRIPTION OF THE DRAWINGS

FIG. 1 is a cross-sectional view which shows an osmosis membrane unit of one embodiment.

FIG. 2 is a schematic block diagram which shows an osmotic pressure power generator of one embodiment.

FIG. 3 is a cross-sectional view which shows an osmotic membrane treatment unit of a first embodiment.

FIG. 4 is a cross-sectional view which shows an osmotic membrane treatment unit of a second embodiment.

FIG. 5 is a graph which shows the results of Examples.

### DETAILED DESCRIPTION

According to one embodiment, an osmosis membrane unit has an osmotic pressure inductor, and an osmosis membrane. The osmotic pressure inductor is one in which a salt-structure compound has reacted with a reticulate member composed or metal. The osmosis membrane is disposed to contact at least one surface: of the osmotic pressure inductor.

Below, various embodiments of an osmosis membrane unit, an osmotic pressure power generator, an osmosis membrane treatment unit, and a method of manufacturing an osmosis membrane unit are described using drawings and the like.

A description is given of an osmosis membrane unit as follows.

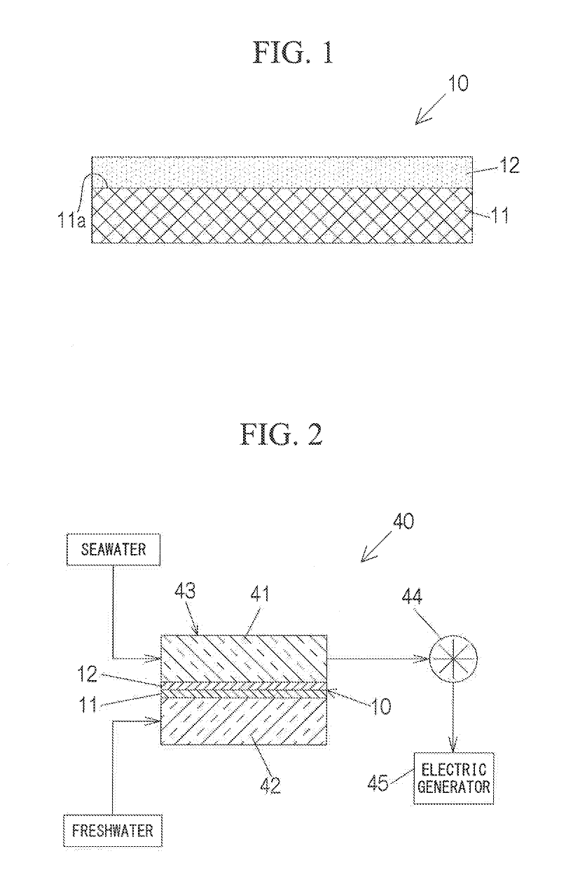

FIG. 1 is a cross-sectional drawing which shows an osmosis membrane unit of one embodiment.

An osmosis membrane unit 10 is provided with an osmotic pressure inductor 11 in which a salt-structure compound has bonded to a reticulate member composed of metal, and an osmosis membrane 12 that is disposed to contact at least one side 1 Is of this osmotic pressure inductor 11.

The reticulate member configuring the osmotic pressure inductor 11 is composed of metal such as iron, copper, or aluminum, or an alloy containing these such as stainless steel or duralumin. As one example of the reticulate member, one may cite a sintered body (metal filter) of metal fiber made of stainless steel.

The aperture diameter of the reticulate member configuring the osmotic pressure inductor 11 should be a ratio capable of trapping particles from several microns to 100 microns in size (several microns signifies from 1 μm to less than 10 μm). As one example, it is preferable to use a reticulate member that has an aperture diameter enabling capture of particles with a size ranging from 10 μm to 40 μm.

If the reticulate member can trap particles having the size which is 10 μm or more, reduction in flow rate due to pressure loss can be prevented. If the reticulate member can trap particles having the size which is 40 μm or less, the osmotic pressure effect that occurs when the below-mentioned salt-structure compound has reacted can be increased.

Examples of a salt-structure compound that reacts with the reticulate member include compounds that can bond to the metal that composes the reticulate member, and that can have or serve a salt structure, e.g., a silane coupling agent. A silane coupling agent bonds to the surface of the reticulate member by utilizing the —OH groups that exist on the surface of the metal composing the reticulate member. Metal oxides exist on the surface of the metal that composes the reticulate member, and some of these generate —OH groups.

These —OH groups can be increased as necessary by causing acid to react with the metal surface. By causing a silane coupling agent to bond with these —OH groups of the reticulate member (a silane coupling reaction), and by subjecting the amino groups of the silane coupling agent to hydrochloric acid treatment, a silane coupling agent provided with a quaternized (quaternary ammonium cations) salt structure is formed.

There are no particular limitations on the silane coupling agent that bonds to the reticulate member, provided that a highly water-compatible structure is introduced into the substituents including carbon that directly bond with the silicon thereof. Examples of a highly water-compatible structure include —OH groups, —NH₂, —NH—, —N═, —NHⱼ⁺, —NH₂⁺—, ═N═⁺, and so on.

Specific examples of silane coupling, agents having a highly water-compatible structure include N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxyoxysilane, N-(vinylbenzyl)-2-aminoethyl-3-aminopropyltrimethoxysilane, (3-ureidopropyl)trimethoxysilane, (3-ureidopropyl)triethoxysilane, trimethyl[3-(triethoxysilyl)propyl]ammonium chloride, and so on. These may be provided with a salt structure, a complex structure, or both by acid, base, or other ions.

As described above, the osmotic pressure inductor 31 is obtained by bonding a silane coupling agent to a reticulate member, and by subjecting the amino groups thereof to hydrochloric acid treatment to provide the silane coupling agent with a salt structure.

The osmosis membrane 12 may be selected at one's discretion. For example, it may consist of a membrane having openings of approximately 2 nm or less that allow passage of water, but that do not allow passage of substances other than water such as ions or salts.

As examples of constituent material of this osmosis membrane 12, one may cite cellulose acetate, aromatic polyamide, polyvinyl alcohol, polysulfone, and so on. Of these, cellulose acetate is mainly used in converting seawater to freshwater. Aromatic polyamide has a high capture rate with respect to salt, but as it tends to adsorb impurities, it is important to conduct pretreatment of the liquid that undergoes osmosis. As polysulfone has a relatively low capture rate with respect to salts, it may be used in a composite membrane in combination with another osmosis membrane or the like.

The osmosis membrane unit 10 is obtained by an arrangement of juxtaposition and/or superimposition of this osmotic pressure inductor 11 and osmosis membrane 12 so that they are brought into simple contact, or by superimposing this osmotic pressure inductor 11 and osmosis membrane 12, and housing them in a framework. it would also be acceptable to have a structure where the osmotic pressure inductor 11 and the osmosis membrane 12 are directly joined using some type of bonding agent. A bonding agent may be selected at one's discretion, and examples thereof include epoxy resin, acrylic resin, and the like.

The osmotic pressure inductor 11 may also be configured as a support member that supports the osmosis membrane 12 when the membrane is flexible. In this case, the osmotic pressure inductor 11 is, for example, formed into a tray-like, shape such as a perforated plate, and the osmosis membrane 12 is placed or fixed thereon to enable support of the osmosis membrane 12.

With respect to the osmosis membrane unit 10 configured in the foregoing manner, a treatment liquid such as seawater flows from the osmosis membrane 12 toward the osmotic pressure inductor 11. At this time, the seawater on the osmosis membrane 12 side is pressurized. The pressure differential between the osmotic pressure inductor 11 side and the osmosis membrane 12 side is, for example, set at 50-60 atmospheres, and in the present embodiment is set at 55 atmospheres.

The salts contained in the seawater are then trapped by the osmosis membrane 12, and freshwater with, for example, an impurity concentration of 0.01 mass % or less flows out to the osmotic pressure inductor 11 side.

When the salts contained in the seawater are trapped by the osmosis membrane 12, the osmotic pressure inductor 11 increases the transmission volume of freshwater that passes through the osmosis membrane 12. That is, the solute concentration of the liquid portion that contacts the osmotic pressure inductor 11 on the freshwater side is in a state where it is provisionally raised higher than the solute concentration of the freshwater by the salt-structure compound of the osmotic pressure inductor 11, thereby reducing the osmotic pressure differential between the seawater side and the freshwater side. In the case where the pressure applied to the seawater side is the same, a larger amount of the real water in the seawater on the osmosis membrane 12 side can be drawn to the freshwater side, enabling seawater-to-freshwater conversion to be efficiently conducted. The concentration of the seawater that is used can be selected at one's discretion, and one may use, for example, seawater with a concentration of 3-4%, and preferably with a concentration of 3.5-3.7%

By means, of the salt-structure compound of this osmotic pressure inductor 11, the transmission volume of freshwater (per unit of time) that passes through the osmosis membrane 12 is increased even at identical pressure. As a result, the osmosis membrane unit 10 of the present embodiment has higher seawater desalination efficiency than in the case of the osmosis membrane 2 alone. By raising desalination efficiency, desalination treatment can be conducted at low cost.

Unlike the general osmotic pressure generation wherein ammonium chloride is used, the salt-structure compound of the osmotic pressure inductor 11 is hardly decomposed and flowed out alter desalination of the treatment liquid. Consequently, the running cost of desalination can be reduced, and the configuration of the desalination process itself can also be simplified.

A description is given of an osmotic pressure power generator as follows.

FIG. 2 is a schematic block diagram which shows an osmotic pressure power generator of an embodiment.

An osmotic pressure power generator 40 of an embodiment is provided with an osmosis membrane module 43 consisting of a first storage unit 41 for storing seawater, a second storage unit 42 for storing freshwater, and the osmosis membrane unit 10 disposed between the first storage unit 41 and the second storage unit 42, a turbine 44 which uses seawater pressurized by this osmosis membrane module 43 as a drive medium, and a generator 45 connected to this turbine 44. The osmosis membrane unit 10 is identical to the osmosis membrane unit 10 shown in FIG. 1 described above.

The seawater stored in the first storage unit 41 is, for example, condensed seawater discharged from a seawater-to-freshwater conversion device, and has a higher salt concentration than ordinary seawater. The freshwater stored in the second storage unit 42 is natural freshwater from waterways and the like, and may also be treated freshwater that is discharged from sewage treatment facilities and the like.

With respect to this osmotic pressure power generator 40, osmotic pressure occurs due to the difference in salt concentration between the seawater stored in the first storage unit 41 and the freshwater stored in the second storage unit 42. The freshwater of the second storage unit 42 passes via the osmosis membrane unit 10 to the seawater of the first storage unit 41. By this means, a high water pressure is generated in the seawater of the first storage unit 41.

Using this high water pressure seawater as a drive medium, the turbine 44 is rotated, and electric power is obtained from the generator 45 by rotation of the turbine 44.

With respect also to this type of osmotic pressure power generator 40, by using the osmosis membrane unit 10, the osmotic pressure inductor 31 increases the transmission volume of freshwater that passes through the osmosis membrane 12. That is, the solute concentration on the seawater side in the first storage unit 41 is provisionally raised by the salt-structure compound of the osmotic pressure inductor 11. By provisionally raising the solute concentration on the seawater side, the osmotic pressure differential between the seawater side in the first storage unit 41 and the freshwater side in the second storage unit 42 is further increased, and the transmission volume of freshwater that passes from the freshwater side to the seawater side is increased. By this means, the osmotic pressure power generator 40 of the present embodiment is able to further raise the water pressure of seawater stored in the first storage unit 41 compared to an osmotic pressure power generator in which the osmosis membrane 12 is provided alone. As a result, it is possible to obtain an osmotic pressure power generator 40 endowed with high power generation efficiency.

A first embodiment of an osmosis membrane treatment unit is described as follows.

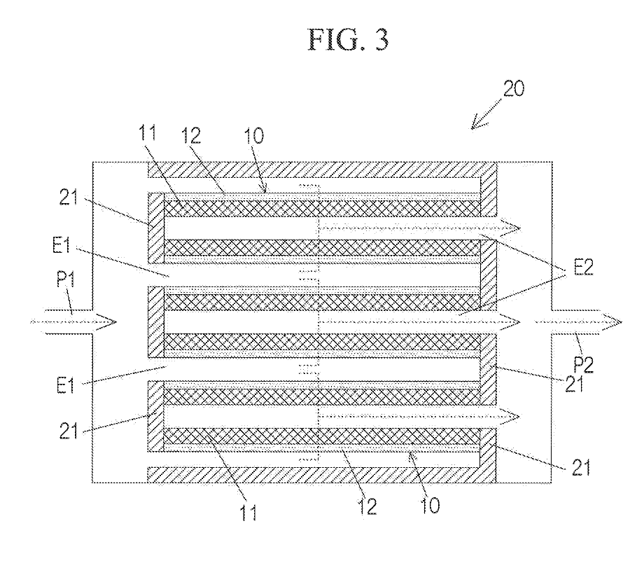

FIG. 3 is a cross-sectional view which shows an osmosis membrane treatment unit of a first embodiment.

An osmosis membrane treatment unit 20 multiply disposes in parallel the osmosis membrane unit 10 of the embodiment shown in FIG. 1. The osmosis membrane units 10, 10 are arrayed at prescribed intervals. The mutually adjacent osmosis membrane units 10, 10 are disposed so as to be opposed such that osmotic pressure inductors 11, 11 thereof face each other. The respective osmosis membrane units 10 are identical to the osmosis membrane unit 10 shown in FIG. 1 described above.

The respective ends of the osmosis membrane units 10, 10 disposed in the above-described manner are supported by elastic bodies 21. The elastic bodies 21 are, for example, formed from rubber or the like, and are formed so as to compartmentalize in a watertight manner a space E1 where the osmosis membranes 12, 12 oppose each other, and a space E2 where the osmotic pressure inductors 11, 11 oppose each other. Specifically, the two ends of each osmosis membrane unit 10 are supported by respectively different elastic bodies 21 so that the space E1 and the space E2 communicate only via the osmosis membrane unit 10. By means of this configuration, two adjacent osmosis membrane units 10 form a space E1 or a space E2.

The space E1 where osmosis membranes 12, 12 oppose each other, and the space E2 where osmotic pressure inductors 11, 11 oppose each other are connected to mutually independent and different flow paths P1, P2.

The osmosis membrane treatment unit 20 configured in this manner can, for example, be applied as a seawater-to-freshwater conversion device. For example, seawater is introduced at a prescribed pressure from the flow path P1 of the osmosis membrane treatment unit 20, with the result that the respective osmosis membranes 12, 12 only allow passage of freshwater, trapping the salts contained in the seawater, The freshwater from which salts have been removed then flows out to the space E2, and the freshwater is discharged from the flow path P2.

With respect also to the osmosis membrane treatment unit 20 of the present embodiment, the transmission volume of freshwater that: passes through the osmosis membrane 12 can be increased by the salt-structure compound of the osmotic pressure inductor 11. Consequently, even with respect to the osmosis membrane treatment unit 20 of the present embodiment, the desalination treatment efficiency with which seawater is desalinated is increased compared to the case where an osmosis membrane 12 alone is used. Low-cost desalination treatment then becomes possible by this increase in desalination treatment efficiency,

With the present embodiment, there is no support member such as a perforated plate to support the osmosis membrane 12, and the osmosis membrane 12 is supported by the osmotic pressure inductor 11 that generates osmotic pressure. By means of this configuration, the aperture ratio at the surface of the osmosis membrane 12 that contacts the seawater is equivalent to 100%, and seawater transmission efficiency is maintained at a high level.

The osmosis membrane treatment unit 20 shown here can also be applied to an osmotic pressure power generator apart from a seawater-to-freshwater conversion device.

A description is given of a second embodiment of an osmosis membrane treatment unit as follows.

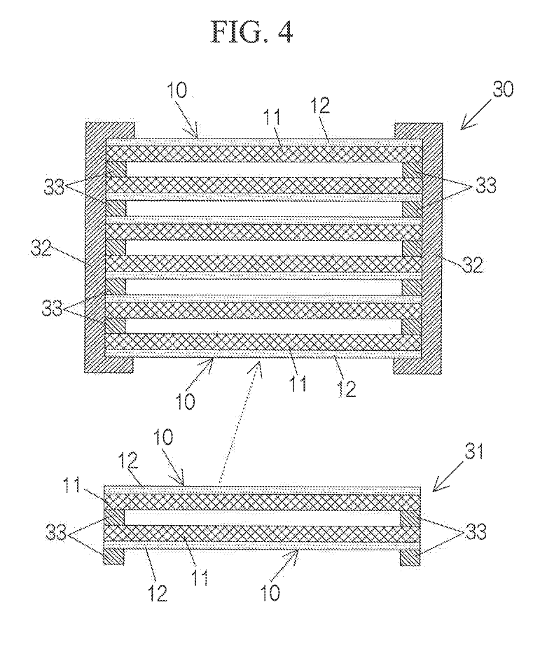

FIG. 4 is a cross-sectional view which shows an osmosis membrane treatment unit of a second embodiment.

The osmosis membrane treatment unit 30 is configured by constituting an osmosis membrane unit pair 31 by providing the osmosis membrane unit 10 of the embodiment shown in FIG. 1 as a set of two, and by fixing a plurality of osmosis membrane unit pairs 31 with fasteners 32. Each osmosis membrane unit pair 31 is disposed so that osmotic pressure inductors 11, 11 are mutually opposed. The osmosis membrane unit 10 is identical to the osmosis membrane unit 10 shown in FIG. 1 described above.

The two ends of each osmosis membrane unit pair 31 are provided with spacer members 33 that preserve a prescribed interval between opposing osmotic pressure inductors 11, 11, and spacer members 33 that preserve a prescribed interval between the osmosis membranes 12 of the neighboring osmosis membrane unit pairs 31. These spacer members 33 are, for example, formed from rubber.

The osmosis membrane treatment unit 30 configured in this manner is formed so that a space E1 between the osmosis membranes 12, 12 wherein the osmosis membranes 12, 12 oppose each other, and a space 132 between the osmotic pressure inductors 11, 11 wherein the osmotic pressure inductors 11, 11 oppose each other are compartmentalized in a mutually watertight manner. The space E1 and the space E2 communicate only via the osmotic pressure inductor 11.

The space E1 where the osmosis membranes 12, 12 oppose each other, and the space E2 where the osmotic pressure inductors 11, 11 oppose each other are connected to different and mutually independent flow paths. In the present embodiment, the near side of the page surface of FIG. 4 is the flow path connected to the space E1 that faces the osmosis membranes 12, 12, and the far side of the page surface of FIG. 4 is the flow path connected to the space E2 that faces the osmotic pressure inductors 11, 11.

In the osmosis membrane treatment unit 30 configured in this manner, for example, seawater is introduced at a prescribed pressure from the flow path connected to the space E1, with the result that only freshwater passes through the respective osmosis membranes 12, 12, trapping the salts contained in the seawater. The freshwater from which salts have been removed then flows out to the space E2, and the freshwater is discharged.

In the osmosis membrane treatment unit 30 of the present embodiment, the transmission amount of the freshwater that passes through the osmosis membrane 12 can be increased by the salt-structure compound of the osmotic pressure inductor 11. Consequently, with respect also to the osmosis membrane treatment unit 30 of the present embodiment, the desalination treatment efficiency with which seawater is desalinated is higher than in the case of the osmosis membrane 12 alone. By raising desalination treatment efficiency, desalination treatment then becomes possible at low cost.

In the present embodiment, as the multiple osmosis membrane unit pairs 31 are held in place by the fasteners 32, there is no need to bond together individual osmosis membrane units 10. Accordingly, maintenance and replacement of the respective osmosis membrane units 10, 10 can be facilitated. Moreover, desalination capacity can be easily enhanced by adding to the number of inserted osmosis membrane unit pairs 31.

The osmosis membrane treatment unit 30 shown here can also be applied to an osmotic pressure power generator apart from a seawater-to-freshwater conversion device.

In the osmosis membrane unit 10 of each embodiment, for example, with respect to two liquids having mutually different salt concentrations, the osmotic pressure inductor 11 should be disposed on the side where osmotic pressure is to be raised.

For example, with the reverse osmosis membrane (RO membrane) method, by disposing the osmotic pressure inductor 11 on the freshwater side, the solute concentration of the liquid portion contacting the osmotic pressure inductor 11 on the freshwater side is in a state where it is provisionally higher than that of the freshwater due to the salt-structure compound of the osmotic pressure inductor 11. Consequently, the osmotic pressure differential between the seawater side and the freshwater side is reduced, and in the case where the pressure applied to the seawater side is identical, more of the real water in the seawater on the osmosis membrane 12 side can be drawn to the freshwater side.

With the forward osmosis membrane (FO membrane) method, by disposing the osmotic pressure inductor 11 on the seawater side, the salt concentration on the seawater side is provisionally raised, further increasing the osmotic pressure differential between the seawater side and the freshwater side. Consequently, the transmission amount of freshwater that passes from the freshwater side to the seawater side is further increased.

A method of manufacture of the osmosis membrane unit is described as follows.

When manufacturing the osmosis membrane unit of the embodiment shown in FIG. 1, first, the reticulate member that configures the osmotic pressure inductor 11 is prepared. As the reticulate member, one may use, for example, a sintered compact of metal fiber of stainless steel (a metal filter).

This reticulate member is immersed, for example, in hydrochloric acid to increase the —OH groups in the surface. Next, the reticulate member in which —OH groups have been increased is immersed in a silane coupling agent reaction solution, As a result of silane coupling reaction, the silane coupling agent bonds with the —OH groups in the surface of the reticulate member.

Next, the reticulate member in which the silane coupling agent has bonded is immersed in, for example, hydrochloric acid to form a salt structure wherein the amino groups of the silane coupling agent are quaternized (quaternary ammonium cation). By this means, a reticulate member having a salt-structure compound can be manufactured.

The osmosis membrane unit 10 of the embodiments can be manufactured by disposing the osmotic pressure inductor 11 composed of a reticulate member having a snit-structure compound obtained in this manner, and the osmosis membrane 12 composed of for example, a hollow fiber membrane, a spiral membrane, a tubular membrane, or the like so that they come into mutual contact.

According to at least one of the embodiments described above, an osmosis membrane unit has an osmotic pressure inductor and an osmosis membrane. The osmotic pressure inductor is one in which a salt-structure compound has reacted with a reticulate member composed of metal. The osmosis membrane is arranged to contact at least one of the surfaces of the osmotic pressure inductor. According to the osmosis membrane unit of these embodiments, with respect to two liquids between which the osmosis membrane is interposed, the osmotic pressure of the liquid of an arbitrary side can be raised, and the flow rate of the liquid that passes through the osmosis membrane can be increased.

That is, according to one of the embodiments, it is possible to offer an osmosis membrane unit, an osmotic pressure power generator, an osmosis membrane treatment unit, and a method of manufacture of an osmosis membrane unit that enables the water transmission amount of the osmosis membrane to be increased,

### EXAMPLES

### Example 1

In order to confirm the effects of the osmosis membrane unit of the embodiments, high-pressure tests were conducted. As the high-pressure tester, High-Pressure Tester C40-B manufactured by Nitto Denko Corporation was used. This high-pressure tester is normally used for high-pressure testing. The C40-B was charged with 100 cc of freshwater; a rubber O-ring, an osmosis membrane, and an osmotic pressure inductor were set up in that order in the cell portion; pressurization was conducted by a nitrogen gas to create an osmotic pressure of 1 MPa; and flow rate measurement was conducted. Thus, the osmosis membrane was disposed in the forward direction.

As the osmosis membrane, an RO membrane of 75 mm diameter—the ES20 manufactured by Nitto Denko Corporation—was cleaned with running water, and used. With respect to flow rate measurement, 5 minutes after the start of pressurization, a 1-minute flow rate of an identical sample was measured 3 times using an electronic scale, and the average value of these values was adopted as the flow rate.

As the osmotic pressure inductor, a reticulate member composed of SUS of 75 mm diameter was used. This was immersed for 1 minute in 1 normal hydrochloric acid, washed for 3 minutes in freshwater, and immersed for two hours in an alcohol solution of a silane coupling agent. As the silane coupling agent alcohol solution, 0.1 g of N-(2-aminoethyl)-3-aminopropyltrimethyloxy silane, 2 g of water, and 8 g of ethanol were mixed and used.

After the silane coupling reaction, the reticulate member was washed with 200 cc of water, and dried for 2 hours at 110° C. After completion of drying, it was immersed for 1 minute in 1 normal hydrochloric acid to form a salt-structure compound, washed for 3 minutes in freshwater, and then used as the osmotic pressure inductor.

Results of flow rate measurement of the osmosis membrane unit of Example 1 are shown in Table 1.

With respect to the unprocessed filter in the table, an unprocessed reticulate member was used with the osmosis membrane, i.e., in a state prior to formation of the salt-structure compound on the reticulate member, and measurement was conducted for reference purposes. ES20 is the result of measurement with the osmosis membrane alone. Exp indicates use of the osmosis membrane unit of the embodiments. Testing was conducted with use of 3 types of reticulate members.

TABLE 1

| | | | Increase- | Increase- |
|---|---|---|---|---|
| | | Flow | decrease | decrease |
| SUS | exp. | rate | rate (%) | rate (%) vs. |
| filter | No. | m/h | vs. ES20 | unprocessed |
| WINTEC SUS 10 μ | exp 1 | 0.0581 | −4.8 | 5.1 |
| | unprocessed | 0.0553 | −9.3 | |
| | filter | | | |
| | exp 2 | 0.0582 | −4.6 | 5.2 |
| | unprocessed | 0.0553 | −9.3 | |
| | filter | | | |
| | exp 3 | 0.0576 | −5.6 | 4.2 |
| | unprocessed | 0.0553 | −9.3 | |
| | filter | | | |
| WINTEC SUS 40 μ | exp 4 | 0.0617 | 1.1 | 3.7 |
| | unprocessed | 0.0595 | −2.5 | |
| | filter | | | |
| Nichidai SUS 15 μ | exp 5 | 0.0652 | 6.9 | 14.0 |
| | unprocessed | 0.0572 | −6.2 | |
| | filter | | | |
| ES20 only | | 0.061 | | |

According to the results shown in Table 1, it could be confirmed in all cases that the osmosis membrane unit of the embodiments was effective in improving the pressure loss that occurs without processing, and in increasing flow rate. Moreover, pressure loss was less with a trappable particle size of 40 μm, compared to one of 10 μm. On the other hand, it was possible to confirm a major improvement in flow rate with use of the filter manufactured by Nichidai.

### Example 2

In order to confirm the effects of the osmosis membrane unit of the embodiment, high-pressure testing was conducted. As the high-pressure tester, High-Pressure Tester C40-B manufactured by Nitto Denko Corporation was used. The C40-B was charged with 200 cc of 0.2 mass % saltwater; a rubber O-ring, an osmosis membrane, and an osmotic pressure inductor were set up in that order in the cell portion; pressurization was conducted by a nitrogen gas to create an osmotic pressure of 1 MPa; and flow rate measurement was conducted.

As the osmosis membrane, an RO membrane of 75 mm diameter—the ES20 manufactured by Nitto Denko Corporation—was cleaned with running water, and used. With respect to flow rate measurement, 4 minutes after the start of pressurization, a 1-minute flow liquid was collected by a sample tube, and measured with a scale. The desalination rate was measured using a conductivity type concentration meter—the PAL-ES1 (Atago Ltd.).

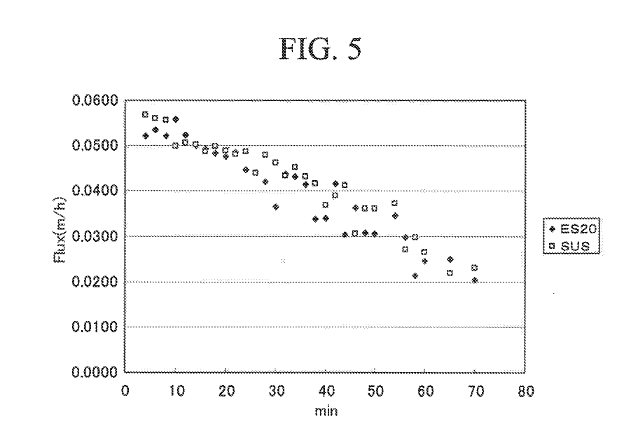

The flow rate measurement results of the osmosis membrane unit of Example 2 are shown as a graph in FIG. 5.

The black symbols (♦) in the graph are the results obtained by measurement with the osmosis membrane alone. With respect to SUS processing (□), the osmosis membrane unit of the embodiments was used.

According to the results shown in FIG. 4, compared to the osmosis membrane alone, an average flow rate increase of 6.9% was observed with the osmosis membrane unit of the embodiments. The osmosis membrane unit of the embodiments exhibited a desalination rate of 100% until 60 minutes, and 90% thereafter. Consequently, it was confirmed that the osmotic pressure capability of the osmosis membrane unit of the embodiments is at a level that matches saltwater of 0.2 mass %.

While certain embodiments have been described, these embodiments have been presented by way of example only, and are not intended to limit the scope of the inventions. Indeed, the novel embodiments described herein may be embodied in a variety of other forms; and various omissions, substitutions and changes may be made therein without departing from the spirit of the inventions. The accompanying claims and their equivalents are intended to cover such forms or modifications as would fall within the scope and spirit of the inventions.

What is claimed is:

1. An osmosis membrane unit, comprising
an osmotic pressure inductor in which a salt-structure compound is bonded to a surface of a reticulate member composed of metal, and
an osmosis membrane that is disposed to contact at least one surface of the osmotic pressure inductor.

2. The osmosis membrane unit according to claim 1, wherein the salt-structure compound is a silane coupling agent.

3. An osmotic pressure power generator, comprising:
a first storage unit that stores seawater;
a second storage unit that stores freshwater;
an osmosis membrane module which is the osmosis membrane unit according to claim 1, and is disposed between the first storage unit and the second storage unit;
a turbine that uses seawater as a drive medium wherein the seawater is pressurized by the osmosis membrane module; and
a generator that is connected to the turbine.

4. An osmosis membrane treatment unit, comprising
a plurality of the osmosis membrane units according to claim 1 and
elastic bodies which support the osmosis membrane units, wherein
the osmosis membrane units are disposed in parallel,
the osmotic pressure inductors of the osmosis membrane units oppose each other while maintaining an interval by the elastic bodies, and
the first area provided between the osmosis membranes that are opposed to each other and the second area provided between the osmotic pressure inductors that are opposed to each other are connected to different and independent flow paths.

5. A method of manufacturing the osmosis membrane unit according to claim 1, sequentially comprising:
a step of immersing a reticulate member composed of metal in a silane coupling agent reaction liquid, and a step of subjecting the reticulate member to hydrochloric acid treatment.

6. The osmotic pressure power generator according to claim 3, wherein the salt-structure compound is a silane coupling agent.

7. The osmosis membrane treatment unit according to claim 4, wherein the salt-structure compound is mane coupling agent.

8. The method of manufacture of an osmosis membrane unit according to claim 5, wherein the salt-structure compound is a silane coupling agent.
